(19) United States
(12) Patent Application Publication
(10) Pub. No.: US 2007/0183318 A1
(43) Pub. Date: Aug. 9, 2007

(54) Outage notification, such as fixed network positive outage notification

(76) Inventors: Matthew Johnson, Spokane, WA (US); David J. Ronalds, Liberty Lake, WA (US)

Correspondence Address: PERKINS COIE LLP;PATENT-SEA, P.O. BOX 1247, SEATTLE, WA, 98111-1247, US

(21) Appl. No.: 11/702,435

(22) Filed: Feb. 5, 2007

Related U.S. Application Data
(60) Provisional application No. 60/764,823, filed on Feb. 3, 2006.
(60) Provisional application No. 60/788,653, filed on Apr. 3, 2006.
(60) Provisional application No. 60/771,829, filed on Feb. 9, 2006.
(60) Provisional application No. 60/765,497, filed on Feb. 3, 2006.

(51) Int. Cl. H04J 3/14

(52) U.S. Cl. 370/225; 340/870.03

(57) ABSTRACT

Methods and systems of providing positive outage notification are described. In some examples, the system determines there is an outage at a facility and transmits multiple messages notifying a utility of the outage. In some examples, the messages are received at multiple message collectors. In some examples, the system determines restoration procedures based on the messages.

### CROSS REFERENCE TO RELATED APPLICATIONS

This application claims the benefit of U.S. Provisional Application No. 60/764,823, entitled “OUTAGE NOTIFICATION, SUCH AS FIXED NETWORK POSITIVE OUTAGE NOTIFICATION,” filed on Feb. 3, 2006 (Attorney Docket No. 101458026US), U.S. Provisional Patent Application No. 60/765,497 filed on Feb. 3, 2006, entitled SYSTEM FOR VERIFYING RESTORED OUTAGES, SUCH AS IN THE FIELD OF OUTAGE RESTORATION OF PUBLIC UTILITIES USING AUTOMATIC METER READING (AMR) (Attorney Docket No. 101458025), U.S. Provisional Application No. 60/771,829, entitled “AUTOMATED UTILITY METER READING SYSTEM WITH MESSAGE-TYPE FILTER,” filed on Feb. 9, 2006 (Attorney Docket No. 101458028US); and U.S. Provisional Application No. 60/788,653, entitled “VERSATILE RADIO PACKET COMPATIBLE WITH EXISTING AUTOMATIC READING SYSTEMS,” filed on Apr. 3, 2006 (Attorney Docket No. 1725.207US01) all of which are incorporated by reference in their entirety.

This application is related to commonly assigned U.S. Provisional Patent Application No. 60/585,391, entitled DISTRIBUTED UTILITY QUALITY MONITORING, SUCH AS FOR MONITORING ELECTRICAL POWER QUALITY, filed on Jul. 2, 2004 (Attorney Docket No. 101458009US), commonly assigned U.S. patent application Ser. No. 11/175,963, entitled DISTRIBUTED UTILITY MONITORING, SUCH AS FOR MONITORING THE QUALITY OR EXISTENCE OF A ELECTRICAL, GAS, OR WATER UTILITY, filed on Jul. 5, 2005 (Attorney Docket No. 101458009US1), commonly assigned U.S. patent application Ser. No. ______, entitled SYSTEM FOR VERIFYING RESTORED OUTAGES, SUCH AS IN THE FIELD OF OUTAGE RESTORATION OF PUBLIC UTILITIES USING AUTOMATIC METER READING (AMR), filed concurrently herewith (Attorney Docket No. 101458025US1), and U.S. patent application Ser. No. ______, entitled VERSATILE RADIO PACKETING FOR AUTOMATIC METER READING SYSTEMS (Attorney Docket No. 1725.207US02, enclosed as Appendix “A”), filed concurrently herewith, all of which are incorporated by reference in their entirety.

### BACKGROUND

Power outages and other service interruptions have long been a problem in the utility industry. Some causes of outages include, for example, storms (e.g., wind, heat, lightning, thunderstorms, snow, and so on), trees (which may contact power lines), vehicles (which may crash into utility poles), animals (may make contact with power lines), excavation and construction (which may damage underground cables), equipment failure, a high power demand event, and so on.

Utilities generally become aware of such outages when a customer calls to complain, or when an automated outage system, such as a Supervisory Control and Data Acquisition (SCADA) system, reports an outage. Many utilities use Outage Management Systems (OMS) for outage events to facilitate the coordination of these outage notifications (e.g., SCADA alarm, or a call center receives a call from a customer) with restoration responses by the utility. For example, a typical OMS goes into action based on a customer call or an electronic notification from an automatic monitoring system. The OMS attempts to locate the problem causing the outage and, if successful, provides and prioritizes restoration options for the utility.

However, in many cases there may be a significant period of time between when an outage first occurs and when the outage is reported to the utility. For example, a relatively small outage may occur in the middle of the night, when customers are typically asleep. Many hours may pass before the customer wakes up and reports the outage. Also, if the outage is relatively small, a SCADA type system may not receive enough information to classify the event as an outage, further delaying the notification to the utility.

Additionally, although customer calls and SCADA information alert a utility of possible outages, in many cases they do not provide a utility with enough information to quickly deduce and prepare a restoration response to an outage event. These and other problems exist with respect to a utility's ability to receive notification and provide restoration of outages in a quick and efficient manner.

### BRIEF DESCRIPTION OF THE DRAWINGS

FIG. 1 is a block diagram illustrating an example of components of the positive outage notification system.

FIG. 2 is a block diagram illustrating an example of components of a meter within the positive outage notification system.

FIG. 3 is a flow diagram illustrating suitable data flows that occur in determining and receiving information related to an outage event.

FIG. 4 is a flow diagram illustrating suitable data flows that occur in collecting outage information from a meter.

FIG. 5 is a flow diagram illustrating suitable data flows that occur in a collector that receives outage information and transmits alarm packets to a central collection engine.

FIG. 6 is a flow diagram illustrating suitable data flows that occur in a central collection engine that receives alarm packets and transmits alarm information to an OMS.

FIG. 7 is a flow diagram illustrating suitable data flows that occur in an example of a restoration process.

FIG. 8A is an example display illustrating a report of outages at a certain time.

FIG. 8B is an example display illustrating a report of outage restorations at a certain time.

### DETAILED DESCRIPTION

Described in detail below is a system to provide automated alarm information to Outage Management Systems (or other systems). Electric meters, such as the Centron Utility Meter by Itron, each send out multiple positive outage notification transmissions (which may be sent out on a number of different frequencies) when an outage occurs at a facility connected to or proximate to the meter. The utilization of different frequencies allows for transmissions to be possibly received by more than one collector, adding to the likelihood that a transmission, even a weak one, will be received by a collector, thus initiating the determination and restoration of an outage.

Collectors placed in the area containing the meters (such as on utility poles, large structures, and so on) may receive these outage notification transmissions, and, using certain algorithms, may generate and send alarm messages related to the transmissions. Central collection engines (CCEs) linked to the collectors may receive the alarm messages and may further process and/or filter the alarm messages. In addition, the CCEs may additionally add information to the alarm messages (such as meter identification information), and transmit the alarm messages to an Outage Management System to begin the restoration process.

Therefore, when an outage event occurs, the system is able to generate spatial, frequency and temporal diversity in the identification and response of the outage event, providing the utility with a finer granularity picture of the outage shortly after the event occurs. Following restoration, positive restoration notification messages may then be sent from endpoints to collectors or receivers and ultimately to a central office or head end to indicate restoration and time of that restoration, as well as other functionality described herein. The fast and more complete picture enables a utility to distribute restoration resources to its customers in a faster and more efficient manner, which improves the utility's outage statistics and potentially reduces fines and other penalties from regulators due to poor service.

Various examples of the technology will now be described. The following description provides specific details for a thorough understanding and enabling description of these examples. One skilled in the art will understand, however, that the technology may be practiced without many of these details. Additionally, some well-known structures or functions may not be shown or described in detail, so as to avoid unnecessarily obscuring the relevant description of the various examples.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

Representative System

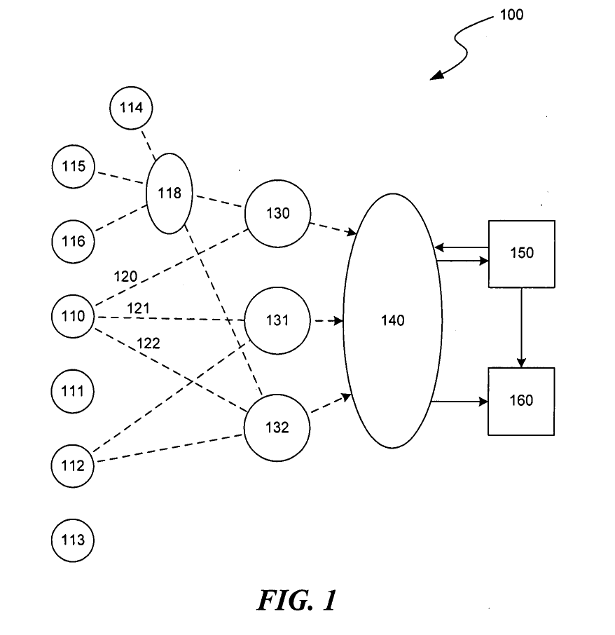

FIG. 1 and the following discussion provide a brief, general description of a suitable environment in which the technology can be implemented. Although not required, aspects of the technology are described in the general context of computer-executable instructions, such as routines executed by a general-purpose computer (e.g., wireless device, or personal/laptop computer). Those skilled in the relevant art will appreciate that the technology can be practiced with other communications, data processing, or computer system configurations, including Internet appliances, handheld devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, mini-computers, mainframe computers, and the like. Indeed, the terms “computer” and the like are generally used interchangeably and refer to any of the above devices and systems, as well as any data processor.

Aspects of the technology can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communication network. In a distributed computing environment, program modules may be located in both local and remote memory storage devices.

Aspects of the technology may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the technology may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the technology reside on a server computer, while corresponding portions reside on a client computer, such as a mobile device.

Referring to FIG. 1, a block diagram illustrating an example of components of the positive outage notification system will be described. FIG. 1 shows an example of a fixed network automatic utility data collection system. Utility meters 110-116, such as a solid state meter with integrated ERT technology (e.g., a Centron meter), may be situated throughout an area. The utility meters 110-116 may be of the same or different types (e.g., electric, gas, water, or other (not shown)). The utility meters may be distributed in a bounded or unbounded geographical area. Each utility meter is connected to or associated with a utility consuming facility. For example, a utility meter may correspond with a household, a commercial facility, or another utility consuming facility or device.

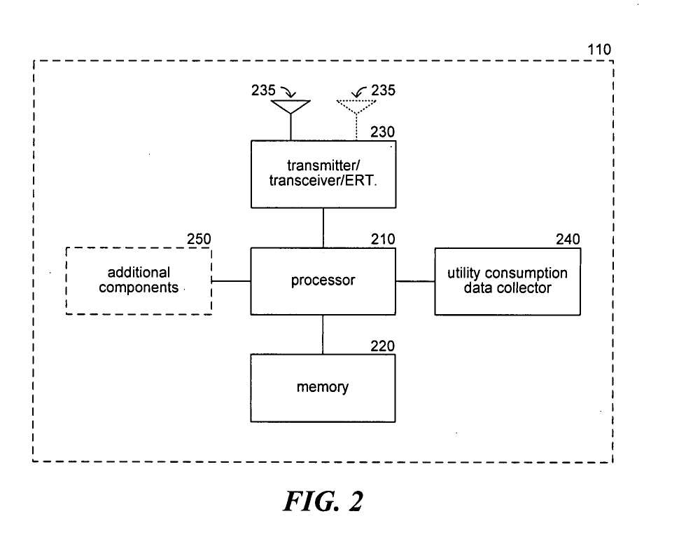

Referring to FIG. 2, a block diagram illustrating an example of the components of a meter (such as meter 110 of FIG. 1) within the positive outage notification system will now be discussed. Meter 110 may include a central processor 210 and a storage component 220 (such as a memory) for storing collected data before transmission to a data collection system. The storage component 220 may also store information identifying the meter, such as a meter identification number. In addition, the meter may be configured with a receiver/transmitter telemetry device (e.g., a transmitter/transceiver such as an encoder receiver transmitter (ERT)) 230 and one or more antennas 235, capable of sending and receiving signals, such as radio packets, alarm signals, and so on. The meter 110 may also comprise a utility consumption data collector 240 capable or collecting data from an associated utility consuming facility and other additional components, such as energy storage components (e.g. batteries, capacitors, and so on) and other additional data collection components.

Referring back to FIG. 1, a repeater 118 (or repeaters) may be placed within the network to extend the range of other meters 114-116 within the network, providing similar signals to the network as the meters 110-113.

In some cases, utility meters 110-113, or repeater 118, send out signals indicating a power outage, such as outage transmissions. For example, meter 110 sends out signals 120-122. One or more signals may be sent on at least three different frequencies as part of a random frequency hopping sequence employed by the meter, providing the system with a safeguard against interfering factors that may delay or attenuate a signal on a single frequency.

Collectors 130-132 may be situated in proximity to the utility meters 110-113 and/or the repeater 118. The collectors 130-132 are configured to receive signals from the utility meters at certain frequencies, and may receive signals from a number of different meters. Accordingly, each collector may contain a multi-channel receiver for simultaneous reception of packets at a number of different frequencies, enabling the system to provide high capacity and reliability in the reception of outage messages from affected meters. Also, because the system may be a configuration of more than one collector receiving signals from the same meter or meters, the system provides a higher reception redundancy for greater delivery reliability of outage messages transmitted from affected meters.

For example, upon detecting an outage, many collectors (such as collector 130, collector 131 and collector 132) may receive the outage signals 120-122 from a possibly affected meter 110. Unlike other systems in which a meter attempts to transmit a lone signal to a single receiver, transmitting many signals, each containing the same outage message, with one or more of the same signals on different frequencies (once or two or more times) to a number of collectors allows for a high “link margin” that enables an increasingly high read reliability (in some cases 50% or higher) at the edge of a collector. “Link margin” refers to the path loss between an endpoint (such as a meter) and a receiver (such as a collector). Therefore, the reliability is higher when there is less path loss between a meter and a collector. This increase in link margin between affected meters corresponds to an increase in the read reliability of a single collector, which may lead to a higher network reception redundancy (in some cases to 3 or 4).

There may be instances where the collectors (at the head end) are overwhelmed with an avalanche of messages (such as in large scale outage events). However, in these avalanche type situations, the meters would likely not be able to transmit messages of any kind. Also, SCADA generally provides sufficient data to handle such avalanche problems. Therefore, the technology may be more effective in positively identifying smaller outage events where finer granularity of the outage information is important in determining the impact and scale of an outage.

After reception of a radio packet, a collector may then decode (using a certain algorithm) the packet to determine if the packet contains an alarm message from the meter. If the collector determines there is an alarm message, it forms an alarm packet containing the alarm message and transmits the alarm packet further down the network to a collection engine linked to the collector. Alarm packets are given higher priority for transmission that regular uploads of meter reading data. To provide greater transmission efficiency during large outages, alarms from meters are grouped together by the collector in alarm packets, reducing network overhead.

The system (or network) provides communication between the collectors 130-132 to a central collection engine (CCE) 140, or multiple CCEs, via a network backhaul or other type of bi-directional communication links. For example, the system may rely on a number of public and private networks, such as GPRS, fiber/Ethernet, POTS, WiFi, and so on. Additionally, the collectors may also utilize Broadband over Powerline (BPL) networks as a backhaul option.

The central collection engine 140 may include (not shown) a web server, message processing component, storage database, external interfaces, and software that controls the processing, management, and distribution of data received from meters. Upon receipt of alarm packets, a CCE 140 may decode the alarm packets to extract the alarm messages. The CCE 140 may institute further processing of the alarm messages as a group, such as eliminating redundant messages, matching alarm messages with restoration messages to eliminate transient events, and so on. The CCEs may also add information from a Meter Data Management (MDM) 150 system or other identifying information (such as service address or transformer identification) to each alarm message. This information may identify the geographic location of the outage, the placement of the outage within a distribution hierarchy, and other identifying information related to the outage, the meter, or both. Once a CCE 140 has finished the required processing, the CCE 140 may transmit the alarm messages and added information to the Outage Management System (OMS) 160. Alternatively, the CCE 140 may send alarm messages to the MDM 150, which then adds the required information discussed above and sends the alarm messages and accompanying information directly to the OMS 160.

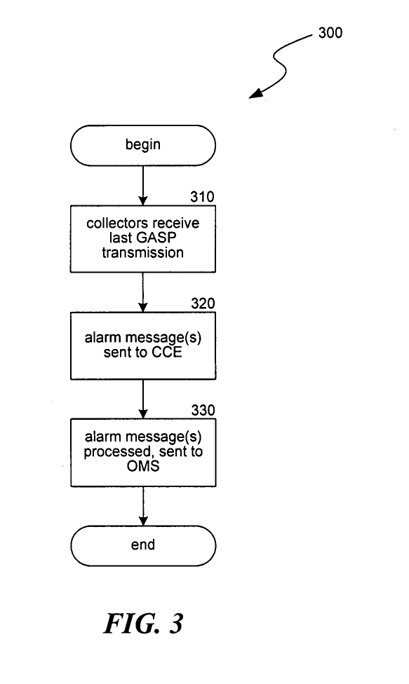

Referring to FIG. 3, an example of a system and network 100 is shown as a routine 300 for determining and receiving information related to an outage event. Beginning in block 310, the routine 300, at a collector or collectors, receives outage transmissions (or alarm messages) from possible affected meters. After receiving the alarm messages, the routine, at block 320, processes and transmits the processed alarm messages to a central collection engine (CCE). Upon receipt of the processed alarm messages, the routine, at block 330, further processes the alarm messages (such as eliminating redundant messages), provides identification and other accompanying information, and transmits the alarm messages and corresponding information to an outage management system (OMS). Further details regarding the steps and processes at each component will be discussed in the following Figures.

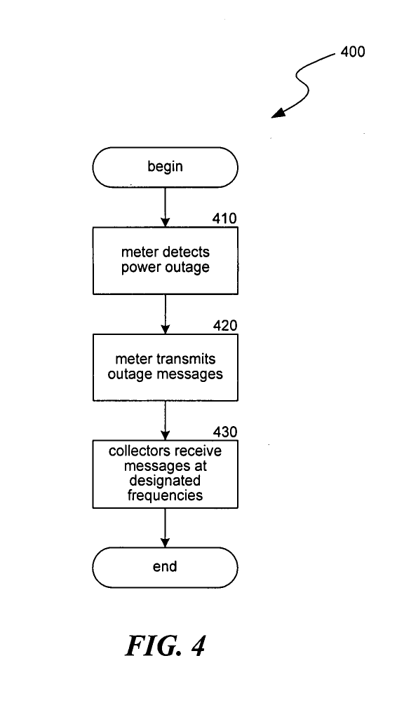

Referring to FIG. 4, an example of the interaction between meter 110 (and repeater 118) and collectors 130-132 is shown as a routine 200 for collecting outage information from a meter. Beginning in block 410, the routine 400, at meters 110, detects a power outage. Using the Centron meter as an example, after AC power is missing for a certain time period (e.g., 60 milliseconds), the meter may determine there is a power outage at a linked facility. Alternatively, other factors may indicate a power outage.

In some cases, the time period and other outage indication variables may be programmable on a meter by meter or network by network basis. For example, a utility may wish to adjust the time period or other variables that indicate a power outage in order to avoid sending irrelevant information to the OMS. Meters could determine outage by counting missing cycles of the AC voltage, a drop in the magnitude of the voltage for a period of time, or some combination of the two. Also, polyphase meters could monitor anomalies of multiple phases.

After detecting the power outage, the routine, at block 420, alerts the network by transmitting radio packets containing alarm messages indicating the power outage. As discussed above, the radio packets are preferably sent on different frequencies to a number of different receivers to increase the likelihood that the radio packets are received by the network.

In some cases, when an outage, such as a power outage, is only for a short duration, power may be restored before the system transmits radio packets containing the alarm messages. In these cases, the system may choose not to send the alarm messages (in order to reduce the number of false outage messages sent to an outage management system) and instead simply log or flag the short term outage and transmit such flags in an interval data message.

At block 430, the routine receives the radio packets at one or more collectors. As discussed above, each of the collectors may comprise a multi-channel receiver to enable the collector to receive packets on a number of different frequencies and to assist the collector with receiving multiple packets at the same time.

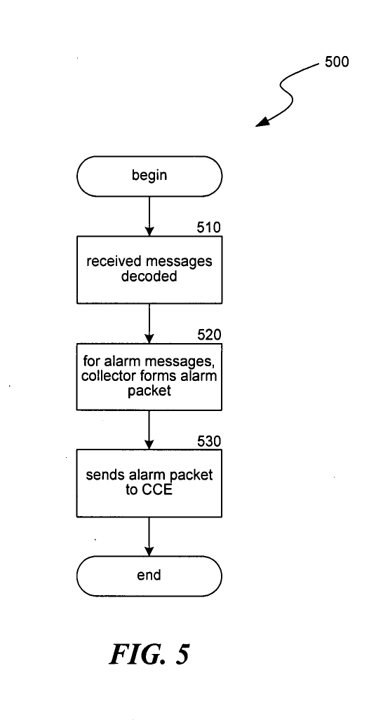

Referring to FIG. 5, an example of the processes within a collector is shown as a routine 500 for receiving outage information and transmitting alarm packets to a central collection engine. Beginning in block 510, after receiving radio packets, the routine 500 decodes the packets to determine which packets contain alarm messages. If a radio packet contains an alarm message, the routine, at block 520, forms an alarm packet containing the alarm message. The routine, at block 530, transmits the alarm packet(s) to a central collection engine (CCE) linked to the collector.

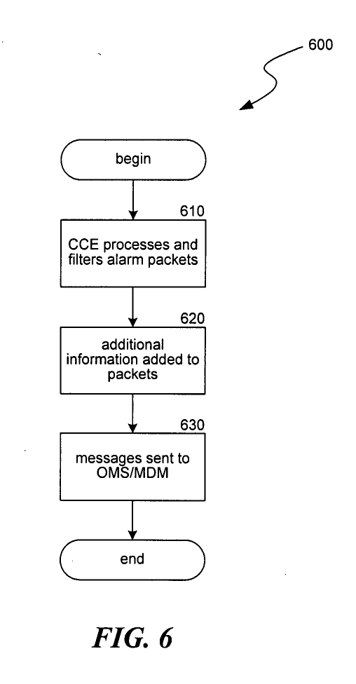

Referring to FIG. 6, an example of the processes within a central collection engine of the system is shown as a routine 600 for receiving alarm packets and transmitting alarm information to an OMS. Beginning in block 610, upon receipt of alarm packets from collectors linked to the CCE, the routine processes and filters the alarm packets to retrieve the alarm messages and prepare them to be received by the OMS. After extracting the alarm messages, the routine, at block 620, adds additional information (such as the identifying information discussed above) to accompany the alarm messages (or, in an alternative example, the alarm messages are sent directly to a MDM to apply the additional information). Once the additional information is added to the alarm messages, the routine, at block 630, transmits the processed alarm messages to the OMS.

In some cases the outage information received from the system may help a utility identify nested outages within a network of meters. For example, the system may verify certain meters that have been restored are no longer sending outage transmissions, but may receive alarm messages from other meters within the network. For example, in these cases, a repair may restore power to a large area but the area may have additional or other damage that prevents restoration to a smaller group of customers. The absence of restoration messages from the smaller area may provide the system information to determine a location of the nested outage, and crews may be sent to that location before leaving the area. Additionally, the system may provide both outage and restoration information to the OMS which may then discover these nested outages, and take the necessary steps in properly restoring an outage. This may avoid the need to send field workers to an area on more than one occasion, which greatly improves the service a utility provides for its customers.

Much of the same process described above may also be employed for positive restoration notification, whereby endpoints transmit a restoration flag or message through the network and ultimately to the central office or other receiving system. In addition, each endpoint may send in its interval data message a flag indicating that power has been restored. As a result, this interval data message can mark an interval (e.g., five minutes) during which power was restored. Because these endpoints may send four hour blocks of interval data at a time, network collectors may receive such messages, even after these collectors have gone down, or are in the process of booting up after a power loss. Since collectors receive both the positive restoration message and the outage flag in the interval data message the overall delivery reliability of restoration messages increases over simply using the positive restoration message alone. This approach also allows collectors that are recovering from outages themselves an opportunity to receive restoration information.

While in the field, the field worker may call the central office to see what endpoints have been restored based on messages that the central office may have received from restored endpoints. Alternatively, the central office may transmit data wirelessly to a mobile endpoint reader device or wireless data receiver (including even a cell phone) to provide such restoration data to the field worker. The central office or field worker may adjust timers or counters at endpoints, such as resetting them to zero. Further details on identifying and restoring endpoints in the field may be found in commonly assigned U.S. application Ser. No. ______, entitled SYSTEM FOR VERIFYING RESTORED OUTAGES, SUCH AS IN THE FIELD OF OUTAGE RESTORATION OF PUBLIC UTILITIES USING AUTOMATIC METER READING (AMR), filed concurrently with this application (attorney docket number 101458025US1).

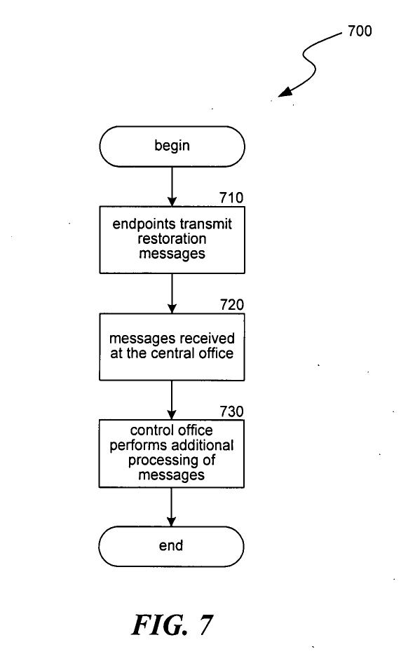

Referring to FIG. 7, a flow diagram showing an example of a restoration process 700 is shown that begins in block 710 where endpoints transmit restoration messages. In block 720, the restoration messages are received (ultimately) at the central office. Then, in block 730, the central office performs additional processing, such as notifying a field worker as noted above. By so notifying the field worker, that worker can identify any nested outages that must still be restored, which avoids the field worker from having to return to the current location to later restore some nested outage that had not been detected.

Under block 730, the central office can also provide notification to customers in a variety of ways. Utilities generally wait for telephone calls from customers in order to realize certain outage situations. The system may facilitate the interaction of a utility with these customers in a number of ways. For example, the system may link to an interactive voice response (IVR) system that provides automated messages to callers indicating known or suspected outages, potential restoration times, and so on. Alternatively or additionally, the system may provide data to a call center (e.g., to display screens at customer support terminals at the call center) so that the call center operators have information regarding the location of outages, approximate response/restoration times, and when restorations have occurred.

By making inferences from the outage data and knowledge of the distribution infrastructure, repairs can be prioritized to restore the greatest number of customers as quickly as possible. (This is generally the purpose of an OMS system that takes SCADA data and Caller ID information from the IVR system to infer what the cause of the outage might be.) Since metrics used by public utility companies (PUCs) to assess penalties are based on the duration of outages and the number of customers affected, prioritizing the restoration efforts can minimize penalties to the utility. This solution offers higher granularity data with which to make these prioritizations potentially reducing costs and penalties for the utility.

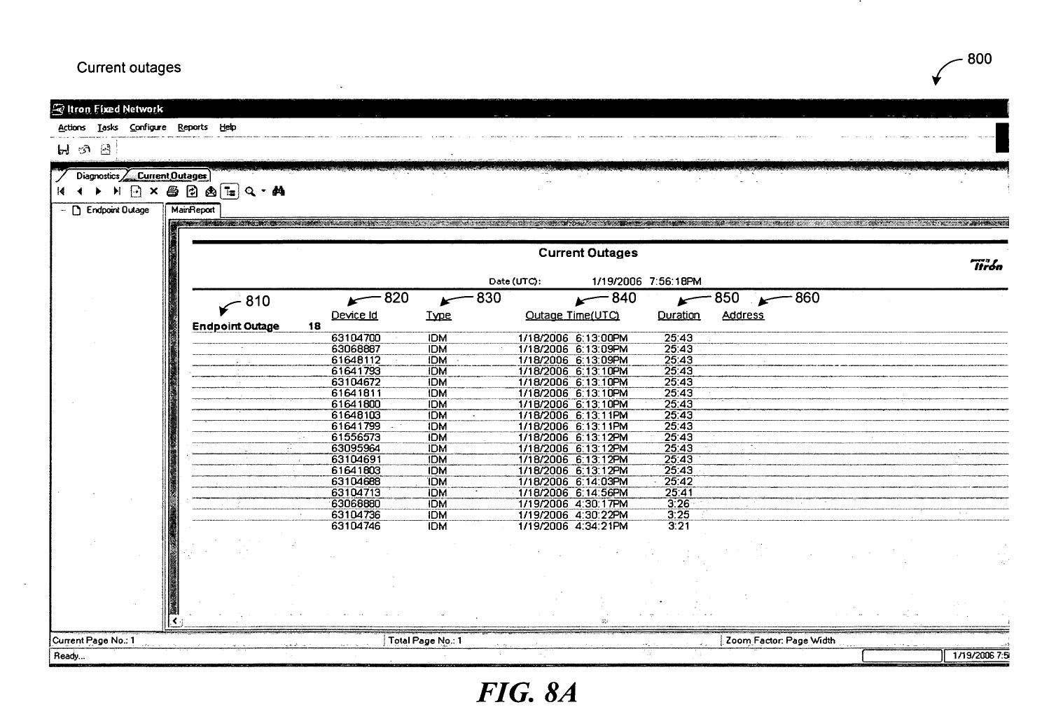

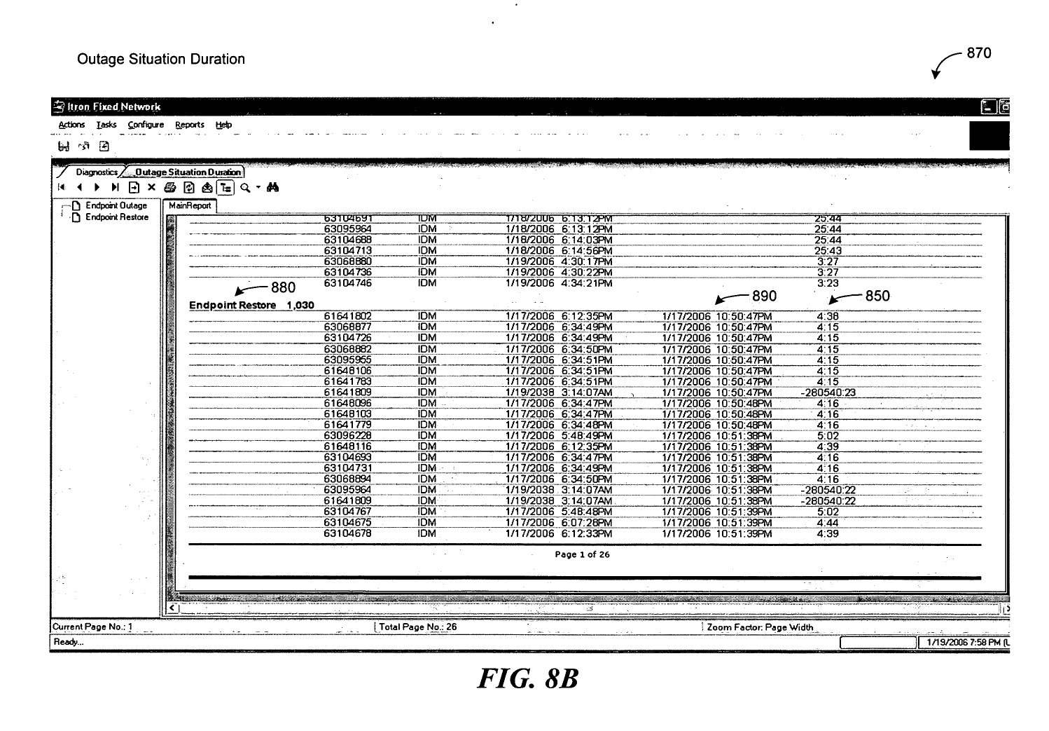

The system may present such data to the utility as screens or reports, such as those illustrated in FIGS. 8A-B. The screens of FIGS. 8A-B may be implemented in C++ or as web pages under XML (Extensible Markup Language), HTML (HyperText Markup Language) or any other scripts or methods of creating displayable data, such as the Wireless Access Protocol (“WAP”). While certain ways of displaying information to users is shown and described with respect to certain Figures, those skilled in the relevant art will recognize that various other alternatives may be employed. The terms “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the system are described herein using a networked environment, some or all features may be implemented within a single-computer environment.

Referring to FIG. 8A, an example display 800 illustrating a report of outages is shown. The report may show the number of outages 810, ID numbers for the devices (such as utility meters) 820 indicating an outage, the type of device or type of message received 830, the time of outage 840 (or time of outage determination), the duration of the outage 850, and other information 860, such as an address.

Referring to FIG. 8B, an example display 870 illustrating a report of outage restorations is shown. For example, in addition to some or all of the information displayed in FIG. 8A, display 870 may also show the number of endpoint or device restorations 880 for a certain time period, the day and time of restoration 890, and so on.

The central office in block 730 can provide the restoration messages to the OMS, the MDM, and so on. Furthermore, under block 730, the central office can provide notification to customers through a variety of ways. In one example, a web server at the central office provides web pages accessible by customers' computers (via a web browser), which display indications of outages, estimated time for restoration, and resulting restorations. Such indications may be provided graphically. In another example, the central office may provide an automated system to send text messages, SMS messages, pre-recorded voice messages, or other telecommunications messages to synchronously or asynchronously notify customers of outages and/or restorations. These messages may also notify certain parties of the utility. Customers can subscribe to the utility (such as via a web page or by calling a customer support number) to request automatic notification of such outages/restorations.

The outage and restoration messages may be provided not only to the OMS, but also workforce management software, such as appropriate enterprise workforce management systems. These systems can, in turn, help with restoration management, including automatically issuing trouble tickets to facilitate restorations. In one example, if the field worker had restored one outage, but recognized a nested outage nearby, the system may actually instruct the field worker to address another outage having a higher priority. The system may then automatically issue a trouble ticket for the nested outage to be restored the following day or in due course. The system may then likewise provide some automated messaging to the affected customers in the nested outage of this fact and when restoration may occur.

Outage and restoration messages from individual meters may be used a triggers to evaluate tamper information from the meters which may indicate theft of energy, such as meter swapping between services. Additionally, the utility may pay fines or incur other penalties when outages are not restored in an acceptable time period. Using aspects of the automatic notification system, a system may be able to reduce or eliminate these penalties as the utility is able to receive quick and reliable outage and/or restoration information.

The system described herein provides utilities with a robust outage notification system capable of identifying and restoring outages before customers are aware of such outages. While embodiments of the invention have been generally described herein as providing time and frequency diversity (by transmitting the same outage message at different times and on different frequencies), alternatively or additionally, embodiments may employ other forms of diversity, such as coding diversity (e.g. using spread spectrum techniques with orthogonal codes), space diversity (e.g. using two or more transmit or receive antennas), and so on.

The system may reduce missing restoration confirmations, and therefore reduce needless man hours wasted during “OK on arrival” calls, may diagnose nested outages as discussed herein and in related applications, and may provide useful information to analyze momentaries and sympathetics for MAIFI (Monetary Average Interruption Frequency Index), CAIDI (Customer Average Interruption Duration Index), and/or SAIDI (System Average Interruption Duration Index) reporting.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the data collection and processing system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

We claim:

1. A fixed network positive outage notification system, comprising:
multiple utility meters that each collect consumption data from a utility, wherein each utility meter includes an outage notification module that wirelessly transmits multiple notification messages upon determining an outage of the utility at the utility meter;
multiple collectors, wirelessly connected to at least some of the utility meters, wherein at least one of the multiple collectors receives at least one of the multiple notification messages from the utility meter, decodes the at least one received notification message to determine contents of the received notification message, and transmits an alarm packet containing an alarm message positively identifying the outage when the determined contents contain a positive indication of the outage at the utility; and
a central collector, communicatively coupled to the multiple collectors, wherein the central collector receives the alarm packet, decodes the alarm packet to extract the alarm message, and transmits the alarm message to an outage management system to begin a process of restoration of the outage.

2. The system of claim 1, further comprising:
a data manager, communicatively coupled to the central collector, that adds identification information about the utility to the alarm message.

3. The system of claim 1, wherein the outage notification module transmits each of the multiple notification messages at a different frequency.

4. The system of claim 1, wherein the outage notification module transmits two or more of the multiple notification messages at a first frequency and two or more of the multiple notification messages at a second frequency different than the first frequency.

5. The system of claim 1, wherein at least one of the multiple collectors is configured to receive multiple notification messages transmitted at a certain frequency.

6. A computer-readable medium storing contents that cause a utility meter to perform a method of notifying a utility provider of an outage at a utility consuming facility associated with the utility meter, the method comprising:
at the utility meter, detecting the outage of the utility as associated with the utility consuming facility, wherein the detecting includes identifying a state of one or more variables related to consumption of the utility; and
at the utility meter, wirelessly transmitting two or more signals, wherein each of the two or more signals each contain information directly related to the outage associated with the utility consuming facility.

7. The computer-readable medium of claim 6, wherein at least one signal of the two or more signals is transmitted at a frequency different than a frequency of the other signals.

8. The computer-readable medium of claim 6, wherein each signal of the two or more signals is transmitted at a frequency unique to the signal.

9. The computer-readable medium of claim 6, wherein at least one signal of the two or more signals is time diverse, frequency diverse, code diverse or spatially diverse from the other signals.

10. The computer-readable medium of claim 6, wherein identifying the state of one or more variables related to consumption of the utility comprises identifying a lack of power at the utility for a predetermined duration.

11. The computer-readable medium of claim 6, wherein identifying the state of one or more variables related to consumption of the utility comprises identifying a missing cycle of AC voltage at the utility.

12. The computer-readable medium of claim 6, wherein identifying the state of one or more variables related to consumption of the utility comprises identifying a drop in voltage at the utility for a predetermined duration.

13. The computer-readable medium of claim 6, wherein the one or more variables to be identified are selected based on characteristics of the utility consuming facility.

14. A method of determining an outage of a utility via a fixed network automated utility data collection system, the method comprising:
receiving at least one of two or more outage notification messages wirelessly sent from a utility meter, wherein the outage notification messages are received by at least one of two or more message collectors located in the fixed network automated utility data collection system, and wherein the two or more message collectors are within wireless range of the utility meter;
reviewing, at the message collectors, outage information related to the outage from the received notification messages, wherein the reviewed outage information is transmitted to a central collector located in the fixed network automated utility data collection system; and
identifying, at the central collector, the outage based on the reviewed outage information.

15. The method of claim 14, wherein each of the received two or more outage notification messages are received at a different frequency.

16. The method of claim 14, wherein each of the received two or more outage notification messages are received by a different message collector.

17. The method of claim 14, further comprising:
removing, at the central collector, redundant outage information from the reviewed outage information.

18. The method of claim 14, wherein identifying the outage comprises receiving identification information related to the utility meter from a meter data manager located in the network.

19. The method of claim 14, wherein identifying the outage at the utility consuming facility comprises comparing the reviewed information to restoration information that indicates recently performed outage restorations of utility consuming facilities in communication with utility meters located in the network.

20. The method of claim 14, further comprising:
alerting customers associated with the utility of the identified outage via a interactive voice response system.

21. The method of claim 14, further comprising:
automatically issuing a work order related to restoring the utility in response to the identification outage.

22. The method of claim 14, further comprising:
associating service address information and transformer identification information related to the utility to the identified outage; and
transmitting the associated information and the identified outage to an outage management system.

23. A positive outage notification system, comprising:
an outage determination component, wherein the outage determination component determines a possible outage associated with a utility consuming facility;
a message transmission component, wherein the message transmission component transmits multiple messages containing information related to the possible outage.
a message reception component, wherein the message reception component receives at least one of the multiple messages;
an message information extraction component, wherein the message information extraction component extracts the information related to the possible outage; and
an outage confirmation component, wherein the outage confirmation component confirms the possible outage as an outage based on the extracted information.

24. The system of claim 19, wherein the outage determination component and the message transmission component are located at a utility meter in communication with the utility consuming facility, and wherein further the message reception component, the message information extraction component, and the outage confirmation component are located on a network shared by the utility meter.

25. A method of confirming a restoration of an outage associated with a utility, the method comprising:
at a utility meter in communication with the utility, wirelessly transmitting two or more signals, wherein each of the two or more signals each contain information directly related to a positive indication of a restoration of the outage associated with the utility; and
at two or more signal collectors located in a fixed network automated utility data collection system and located within wireless range of the utility meter, receiving at least one of the two or more signals.
